(19) United States
(12) Patent Application Publication
(10) Pub. No.: US 2016/0030862 A1
(43) Pub. Date: Feb. 4, 2016

(54) WATER FILTERING SYSTEM

(71) Applicant: OSCAR HUEIMIN WANG, Irvine, CA (US)

(72) Inventor: OSCAR HUEIMIN WANG, Irvine, CA (US)

(21) Appl. No.: 14/875,704

(22) Filed: Oct. 6, 2015

Related U.S. Application Data
(60) Provisional application No. 62/169,355, filed on Jun. 1, 2015.

(51) Int. Cl. B01D 29/56; C02F 1/32; B01D 61/02; C02F 1/44; C02F 1/28

(52) U.S. Cl. CPC B01D 29/56; C02F 1/441; C02F 1/283; B01D 61/025; C02F 1/325; C02F 2103/007

(57) ABSTRACT

A water filtrating system may include a plurality of filters vertically disposed inside a shell, which is used to protect the filters therein. The shell can be single-layered or multi-layered. In one embodiment, the water filtrating system may be coupled with an RO system having controls, a plurality of membranes. The water filtered by the filtering system can be further purified by the RO system. The present invention is advantageous because the filters are vertically disposed inside the shell, so the filters are protected from being damaged and able to survive extreme weather conditions and/or external environmental conditions such as moisture, vibration, shock, etc. Moreover, the size of the entire system is significantly reduced because the filters or filtering components are all vertically disposed inside the shell, so the user can use more than one systems to increase the water output or filtration efficiency.

### CROSS-REFERENCE TO RELATED APPLICATIONS

This application claims priority under 35 U.S.C. §119 (e) to U.S. Provisional Patent Application Ser. No. 62/169,355, filed on Jun. 1, 2015, the entire contents of which are hereby incorporated by reference.

### FIELD OF THE INVENTION

The present invention relates to a water filtering system, and more particularly to a water filtering system including a plurality of filters vertically disposed in a protecting shell, so the filters are protected and the system can be operated under different environmental conditions.

### BACKGROUND OF THE INVENTION

Numerous types of water filtration systems, their component, and filtration methods employed within the systems are known in the art. Known water filtration systems include “point of use” water filters, which are installed locally to a potable water outlet dedicated to a single user, or single apparatus or appliance. Examples include, but are not limited to, water faucets for a kitchen or bathroom sink, a shower or bathtub, a water fountain, and a clothes washing machine. Other known water filtration systems include “point-of-entry” water filters, which are located and installed to filter the water entering a house or business facility, prior to the water flowing into the distribution pipes typically providing water to the above-identified point of use outlets. The entry at which the “point of entry” filter is installed is typically fed by the municipal water supply or a well. The two types of filter systems typically have different capacity requirements, filtering performance, maintenance requirements, and cost, such that an apparatus or system optimized for one may not be optimal for the other.

Multiple stage filters are known in the art of water filtration, both for point of entry and point of use. A typical multiple stage point of use water filtration system includes multiple filter containers or cylinders receiving water from a diverter valve attached to a sink faucet, water supply line to the sink faucet, or to another plumbing connection dedicated to the point of use outlet. The diverter valve typically introduces the unfiltered water to the filter media inside the cylinders, from which it is eventually dispensed through a spigot. The filter cylinders are typically, but not necessarily, oriented vertically with respect to the earth. If the apparatus is visible and accessible, the spigot may be located on, for example, a housing of the apparatus. An example water filter having such a spigot is the kind located on a sink counter, which is commonly referenced as an “above-the-counter” model. The spigot may be separate from the filter apparatus, an example being a second faucet connected to an outlet port of the filter by a feed line, which is commonly referred to as an “under-the-counter” model.

However, conventional multiple stage filters are bulky so it is difficult to move them around. Furthermore, conventional multiple stage filters are vulnerable to external environmental conditions such as cold/hot weather, pressure, moisture, vibration, shock, etc., and the conventional multiple stage filters may break due to external environmental conditions and cause flooding or other more serious problems. Therefore, there remains a need for a new and improved water filtering system to overcome the problems presented above.

### SUMMARY OF THE INVENTION

It is an object of the present invention to provide a water filtering system in which the filtering components are vertically disposed in a receiving space of a shell and protected by the shell.

It is another object of the present invention to provide a water purifying system in which the purifying components are vertically disposed in a receiving space of a shell and protected by the shell.

It is a further object of the present invention to provide a water filtering system coupled with a least one water purifying system in which the filtering and purifying components are vertically disposed inside the water filtering and purifying systems respectively, so the components can be protected from environmental conditions such as cold/hot weather, pressure, moisture, vibration, shock, etc.

It is still a further object of the present invention to provide a water filtering/purifying system to include the filtering/purifying components therein so if one of the filters leaks, a further water damage such as flooding will be prevented.

In one aspect, a water filtrating system may include a plurality of filters inside a shell, which is used to protect the filters therein. In one embodiment, the shell is single-layered. In another embodiment, the shell is multi-layered. The water can flow into the filters from the top of the shell and the filtered water flows out at a bottom portion thereof.

In still another embodiment, the filtrating system is coupled with an RO system which is also disposed in a shell. The RO system may include controls and a plurality of membranes. The water filtered by the filtering system can be further purified by the RO system. The components in the RO system are also arranged vertically in the shell, so the components can also be protected and prevent the adversary effect from the environment. The controls may include an auto shut-off valve, a check valve, sensors, pumps, gauges, flow meter, permeate pump, switches, thermocouple, etc.

In a further embodiment, an RO system may include a plurality of sub-RO systems running in parallel, and a permeate pump may be disposed the RO system to increase the water pressure and further increase the water output rate.

In still a further embodiment, an RO system has a vacuum pump and a shell, and the vacuum pump is configured to suck water into the RO system from an outside water source. In some embodiments, an external pressure tank is configured to increase the water pressure in the RO system.

In another aspect, a water tank with water is disposed on top of a filtration system, which includes a plurality of filters inside a shell. With this configuration, the water can be driven by gravity to pass through the filtration system. In one embodiment, the water can be driven by a mechanical pump, so the water can be pumped from outside into a filtration system, and purified or filtered water can be collected at the bottom thereof.

In a further embodiment, a filtration system can be disposed in a water reservoir, river, or pond to purify the water therein. One end of the filtration system can be coupled with a vacuum pump to drive the water from the other end of the filtration system into the system, and the filtered or purified water can be collected from the pump end. In still a further embodiment, a filtration system includes at least one UV system inside the shell. In still a further embodiment, a filtration system may include insulation materials inside a shell to avoid adversary effect caused by cold or hot weather.

### BRIEF DESCRIPTION OF THE DRAWINGS

FIG. 1 illustrates a schematic view of a water filtering system having vertically arranged filters therein.

FIG. 2 illustrates a schematic view of an RO system having vertically arranged filters and membranes therein.

FIG. 3 illustrates a schematic view of another RO system having vertically arranged filters and membranes therein.

FIG. 4 illustrates a schematic view of an RO system having a different configuration of filters and membranes therein.

FIG. 5 illustrates a schematic view of an RO system having an alternative configuration of filters and membranes therein.

FIG. 6 illustrates a schematic view of an RO system having a plurality of sub-RO system running in a parallel manner.

FIG. 7 illustrates a schematic view of an RO system having a permeate pump therein.

FIG. 8 illustrates a schematic view of an RO system having a booster pump therein.

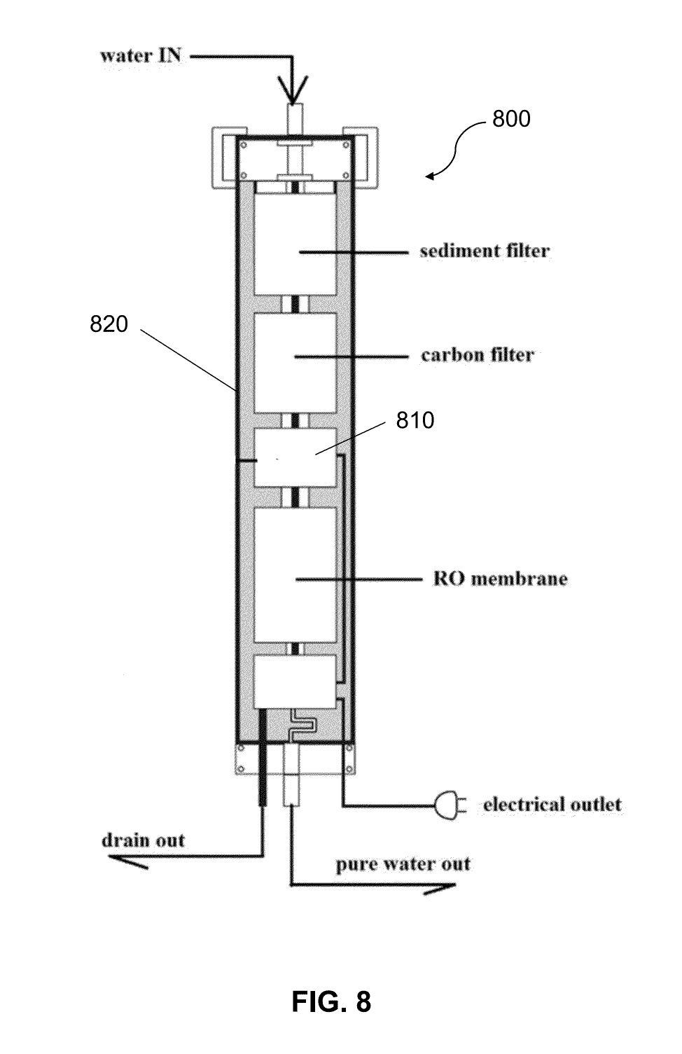

FIG. 9 illustrates a schematic view of an RO system having a vacuum pump therein.

FIG. 10 illustrates a schematic view of an RO system having an external pressure tank.

FIG. 11 illustrates a schematic view of an RO system having an internal pressure tank.

FIG. 12 illustrates a schematic view of an RO system having an external water chamber.

FIG. 13 illustrates a schematic view of a water filtration system with anti-scale media.

FIG. 14 is a schematic view of a water filtration system with a water tank on top of the system.

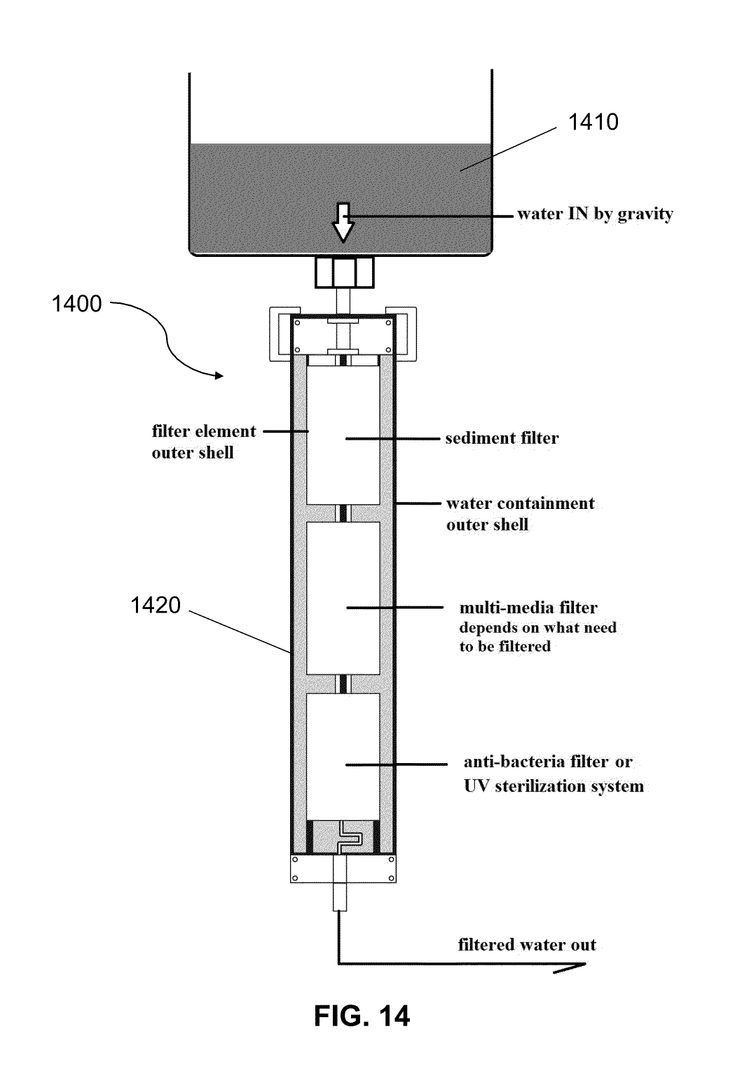

FIG. 15 illustrates a schematic view of a water filtration system, where a mechanical pump is used to pump the water inside the filtration system.

FIG. 16 is a schematic view of a water filtration system used in water reservoir, pond, river, or a moving boat.

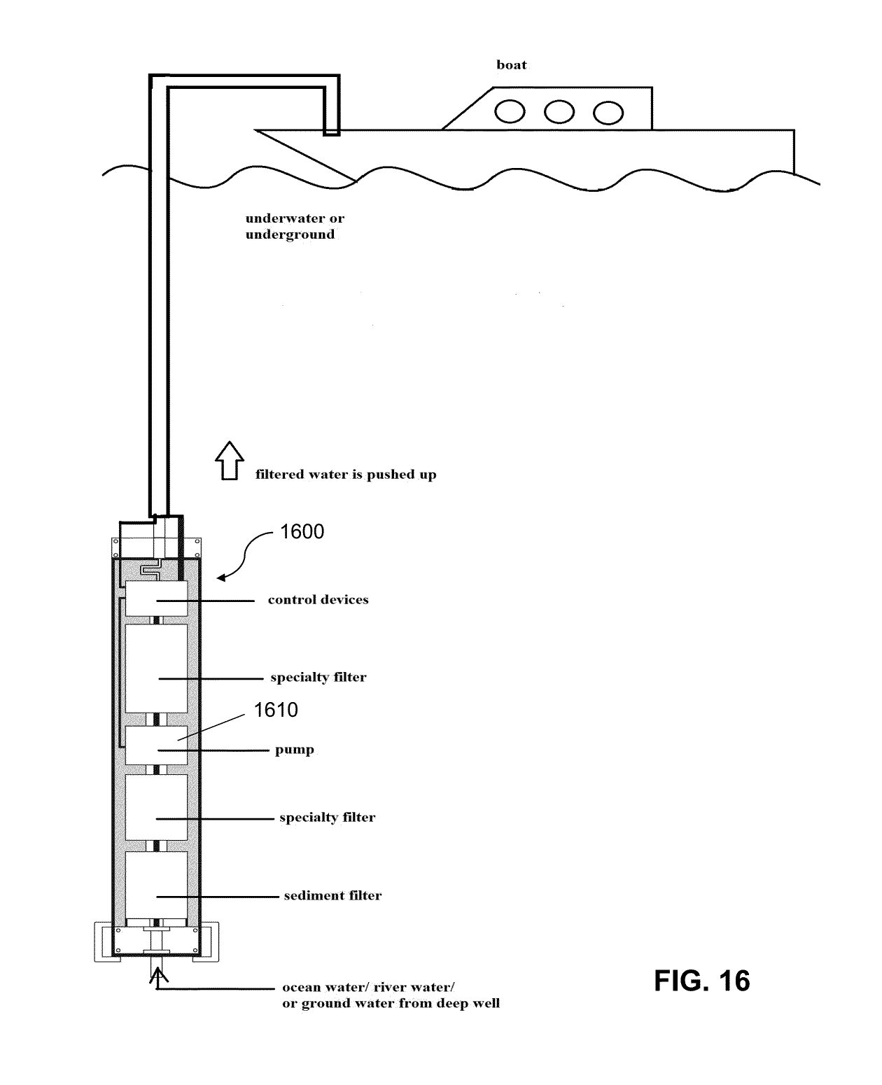

FIG. 17 is a schematic view of a water filtration system with a UV system in the shell.

FIG. 18 is a schematic view of a water filtration system that can survive extreme weather.

FIG. 19 is a schematic view of a water filtration system having a UF/hollow fiber membrane.

FIG. 20 is a schematic view of a water filtration system that can survive moisture.

FIG. 21 is a schematic view of a water filtration system that can survive heat.

FIG. 22 is a schematic view of a water filtration system that can survive a vibrating environment.

FIG. 23 is a schematic view of a water filtration system having multiple-layered shells for different environmental challenges and operating conditions.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

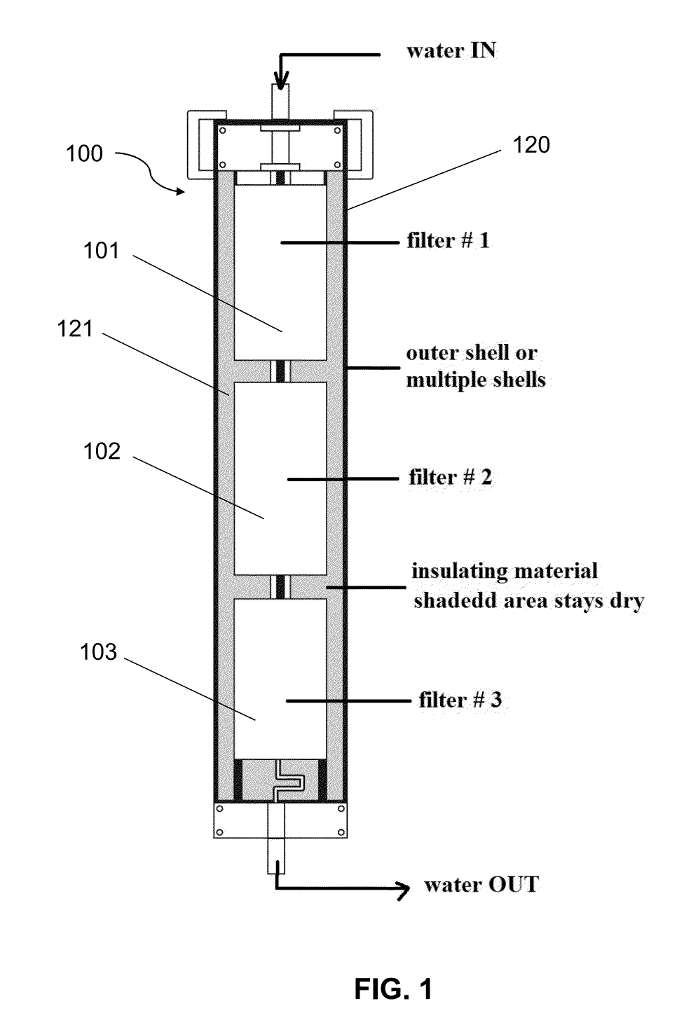

Referring to FIG. 1, a water filtrating system 100 may include a plurality of filters 101, 102 and 103 in a receiving space 121 of a shell 120, which is used to protect the filters 101 to 103 therein. In one embodiment, the shell 120 is single-layered. In another embodiment, the shell 120 is multi-layered. As shown in FIG. 1, the water can be introduced into the filters from the top of the shell 120 and the filtered water flows out at a bottom portion thereof. It is advantageous to vertically dispose the filters 101 to 103 inside the shell 120 because the filters 101 to 103 can be protected therein and if one of the filters is broken, the water will be retained in the shell 120 so it will not cause further damages such as flooding. Also, since the filters are disposed inside the shell 120, the filters will not be affected by external environmental conditions such as cold/hot weather, pressure, moisture, vibration, etc.

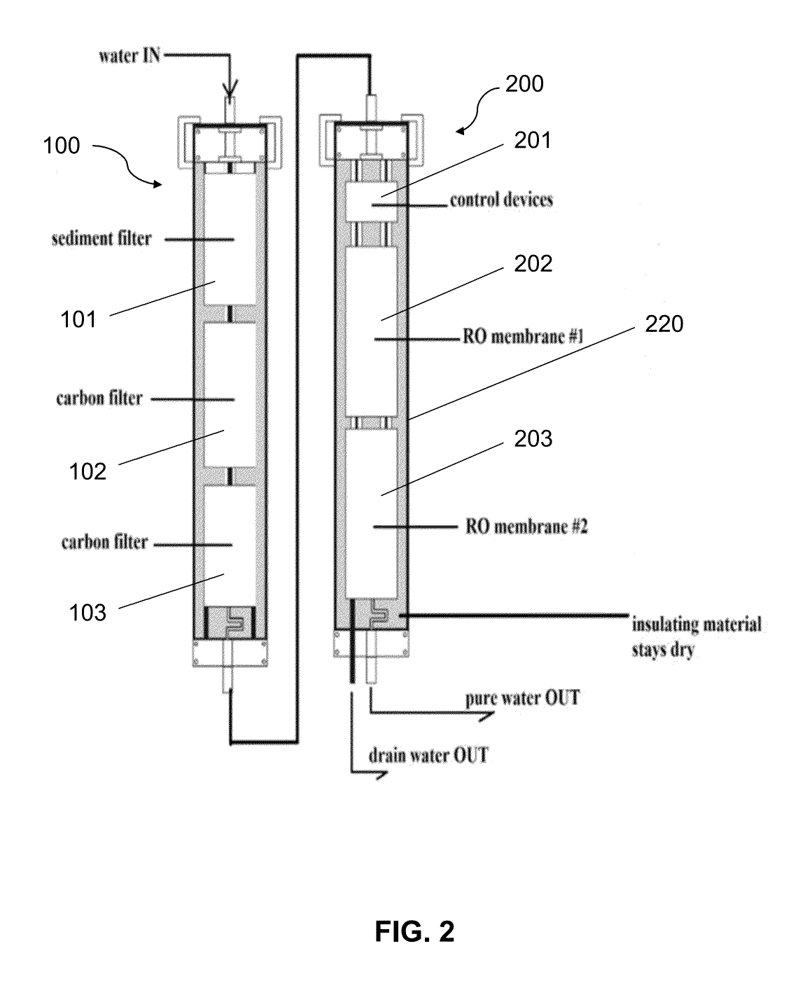

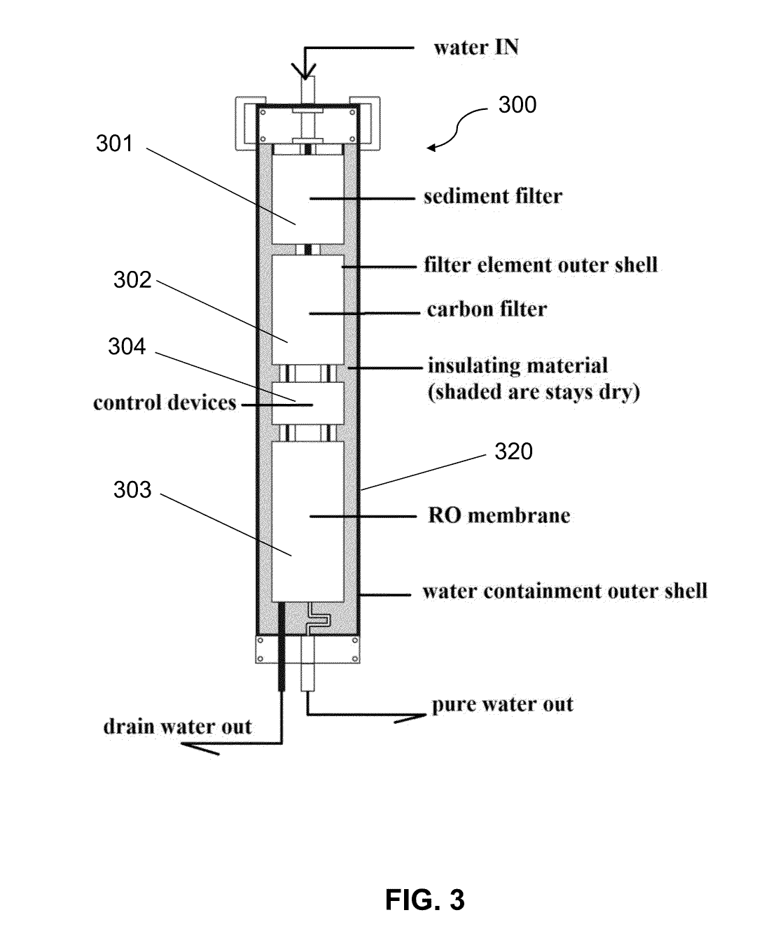

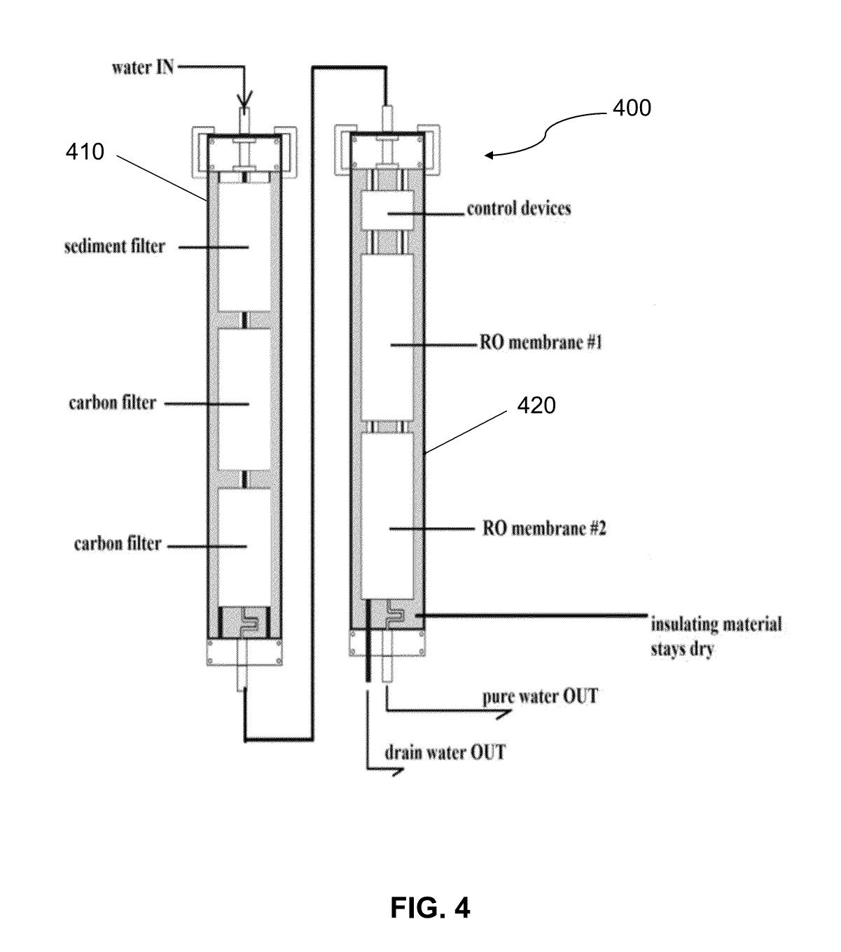

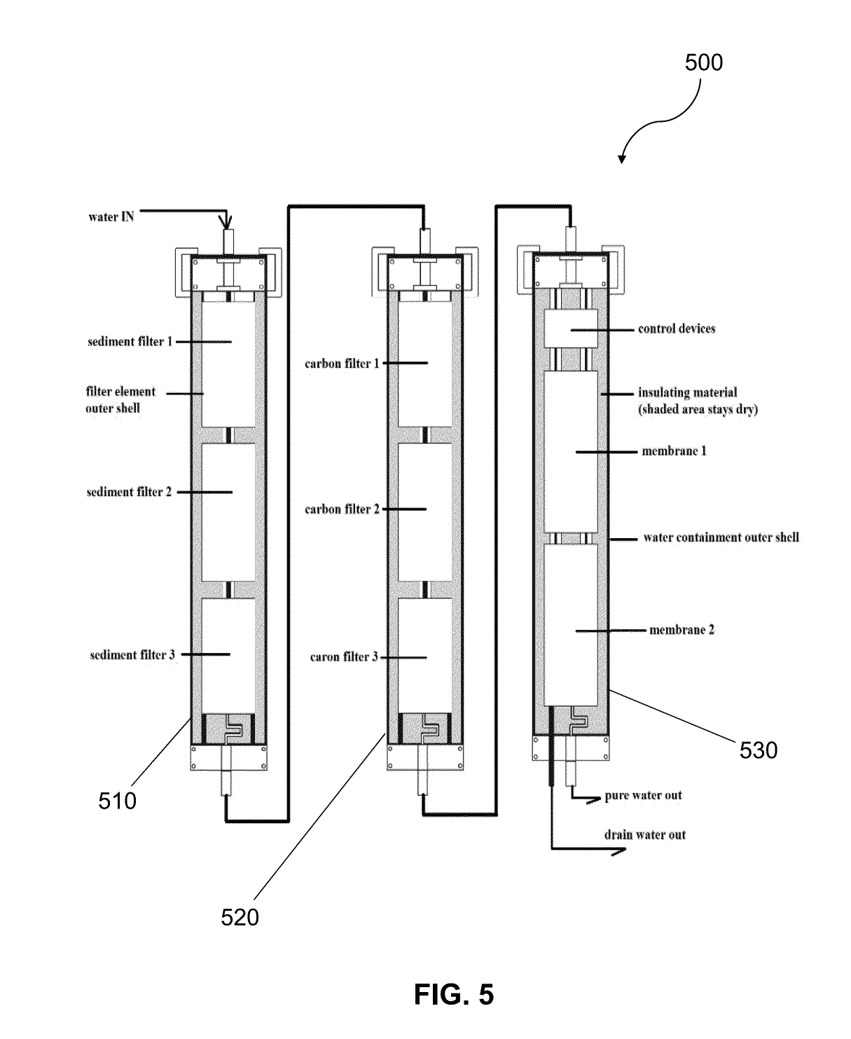

FIG. 2 shows the filtrating system 100 is coupled with an RO system 200, which is also disposed in a shell 220. The RO system 200 may include controls 201, a plurality of membranes 202 and 203. The water filtered by the filtering system 100 can be further purified by the RO system 200. It is noted that the components of the RO system 200 are also arranged vertically in the shell 220, so the components can also be protected and prevent the adversary effect from the environment. The controls 201 may include an auto shut-off valve, a check valve, sensors, pumps, gauges, flow meter, permeate pump, switches, thermocouple, etc. FIG. 3 shows another RO system 300 that has a sediment filter 301, carbon filter 302, RO membrane 303 and controls 304. As discussed above, the components 301 to 304 are arranged in a vertical manner in a shell 320, so the components are protected therein, and such arrangement can significantly reduce the size of the filtering or RO system. FIG. 4 shows a RO system 400 that has filters in one shell 410 and membranes and control devices in the other shell 420, while FIG. 5 shows another embodiment of a RO system 500, which includes a plurality of sediment filters vertically disposed in a first shell 510, a plurality of carbon filters vertically disposed in a second shell 520, and a plurality of membranes and control vertically disposed in a third shell 530.

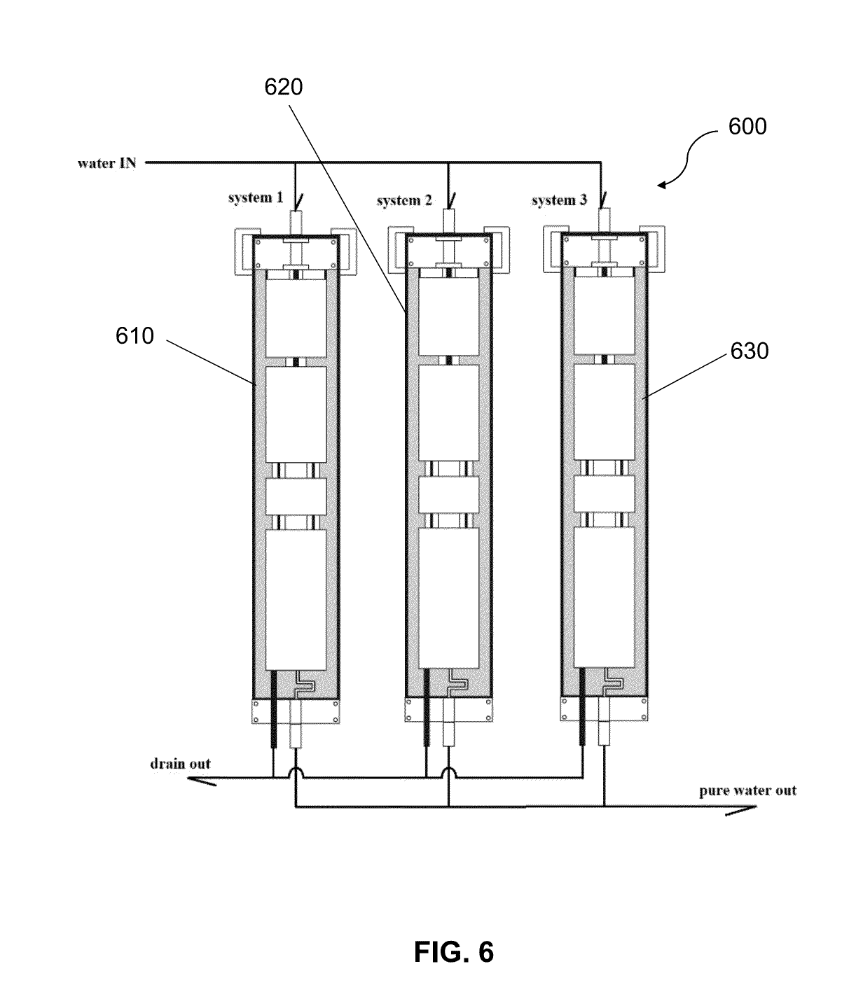

In a further embodiment, an RO system 600 may include a plurality of sub-RO systems 610 to 630 running in parallel. Unlike the RO systems 400 and 500, each sub-RO system in FIG. 6 is a complete RO system to filter and purify the water therein. The RO system 600 is advantageous because every sub-RO system is independently running in a parallel manner and the amount of output water can be increases as the number of the sub-RO system increases. It is noted that the water filtering components are still arranged in a vertical manner in each sub-RO system 610 to 630, so the components are protected therein and such arrangement can reduce the size of the RO system 600.

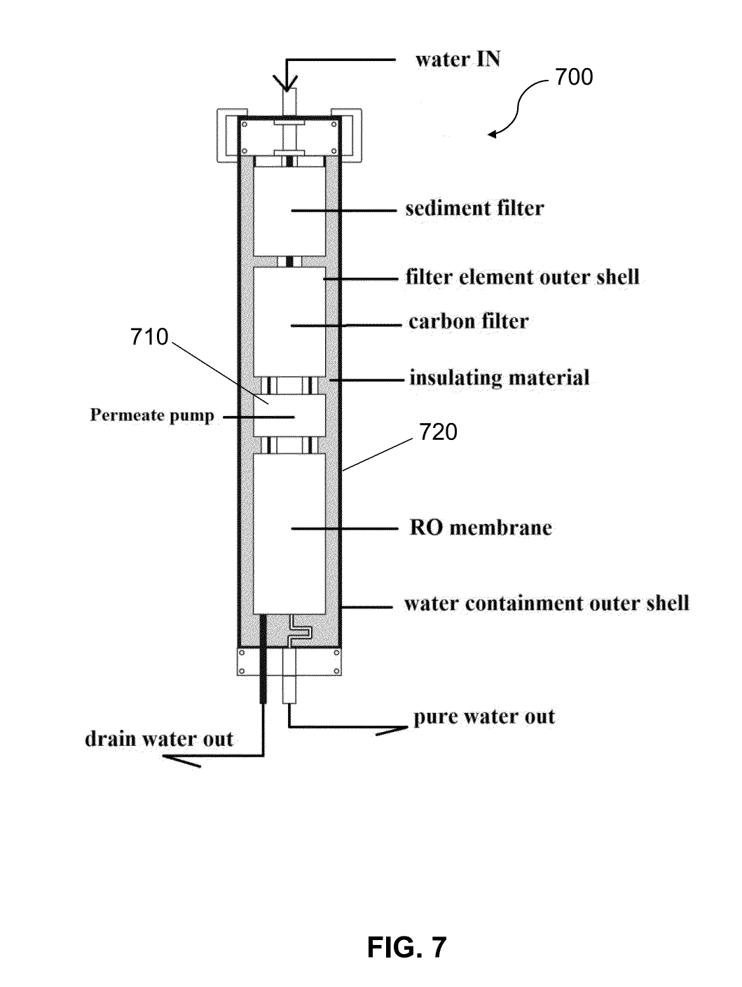

A typical reverse osmosis (RO) system utilizes an automatic shut-off valve (ASO) that stops the RO system from producing water when the holding tank reaches 50%-67% of the incoming water pressure. As the holding tank gets close to being full, the quality of the water produced by the system begins to diminish, as well as sending more water down the drain due to the increasing back pressure from the holding tank. When a permeate pump is installed, the RO membrane is isolated from this back pressure and allows the RO membrane to operate with up to 85% of the incoming water pressure, even when the holding tank is nearly full. This dramatically improves the efficiency of the membrane and overall quality of your water, as well as increasing the pressure and related volume of stored water in the holding tank. As shown in FIG. 7, a permeate pump 710 is disposed in a shell 720 of an RO system 700 to increase the water pressure and further increase the water output rate.

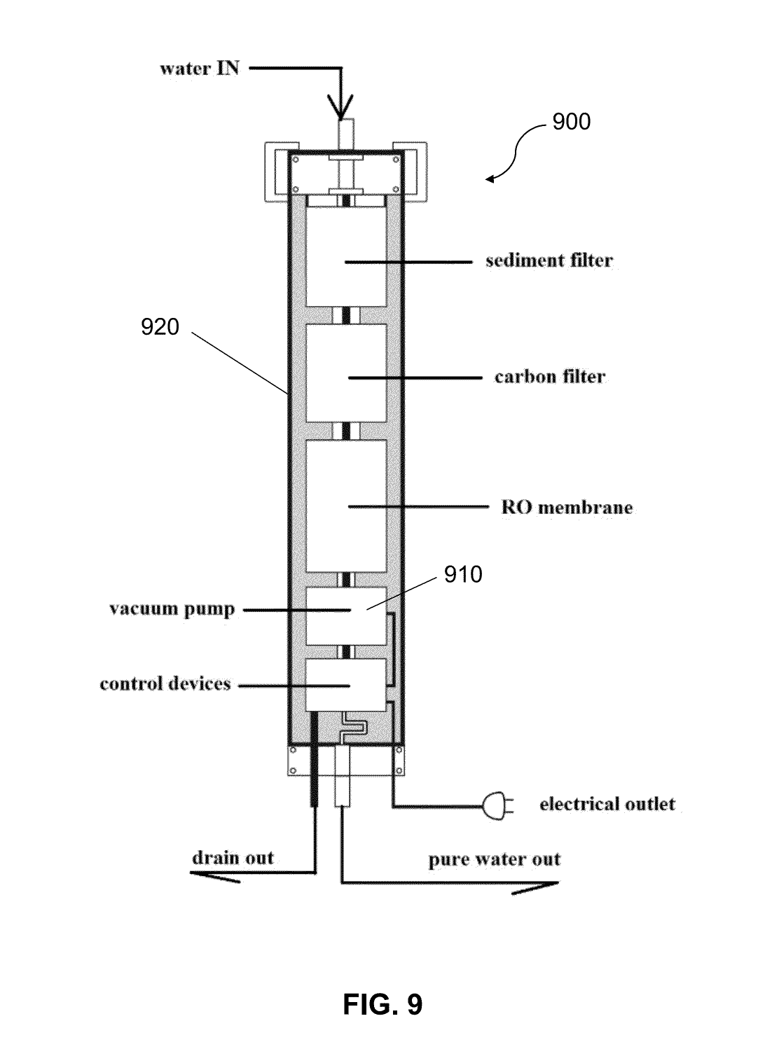

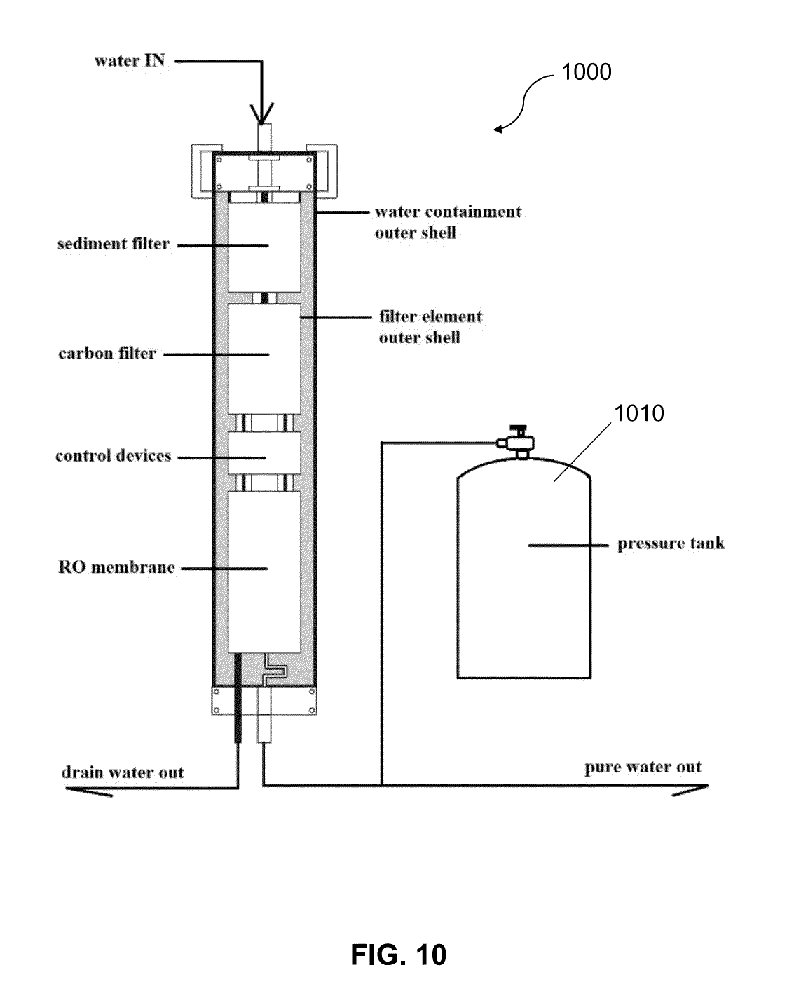

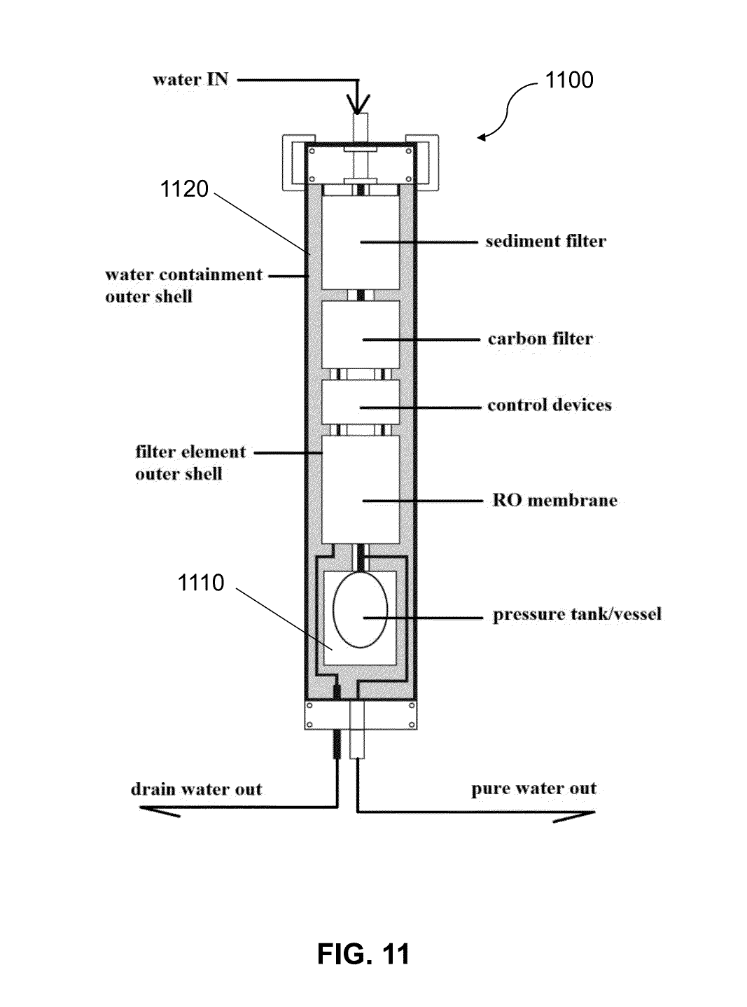

In another embodiment, the RO system 800 may include a pump assembly 810 and a shell 820, wherein the pump assembly 810 includes a pump, a transformer, a solenoid valve, a pressure switch. In another embodiment, the pump assembly 810 may also include sensors and microprocessor controlled components. In a further embodiment, the pump is a booster pump in the pump assembly 810, which is used when the water pressure is below 40 psi. In a further embodiment shown in FIG. 9, an RO system 900 has a vacuum pump 910 and a shell 920, and the vacuum pump 910 is configured to suck water into the RO system 900 from an outside water source. In still a further embodiment, an external pressure tank 1010 is configured to increase the water pressure in an RO system 1000 as shown in FIG. 10. In other embodiments, an RO system 1100 may have a pressure tank 1110 inside the shell 1120 as shown in FIG. 11.

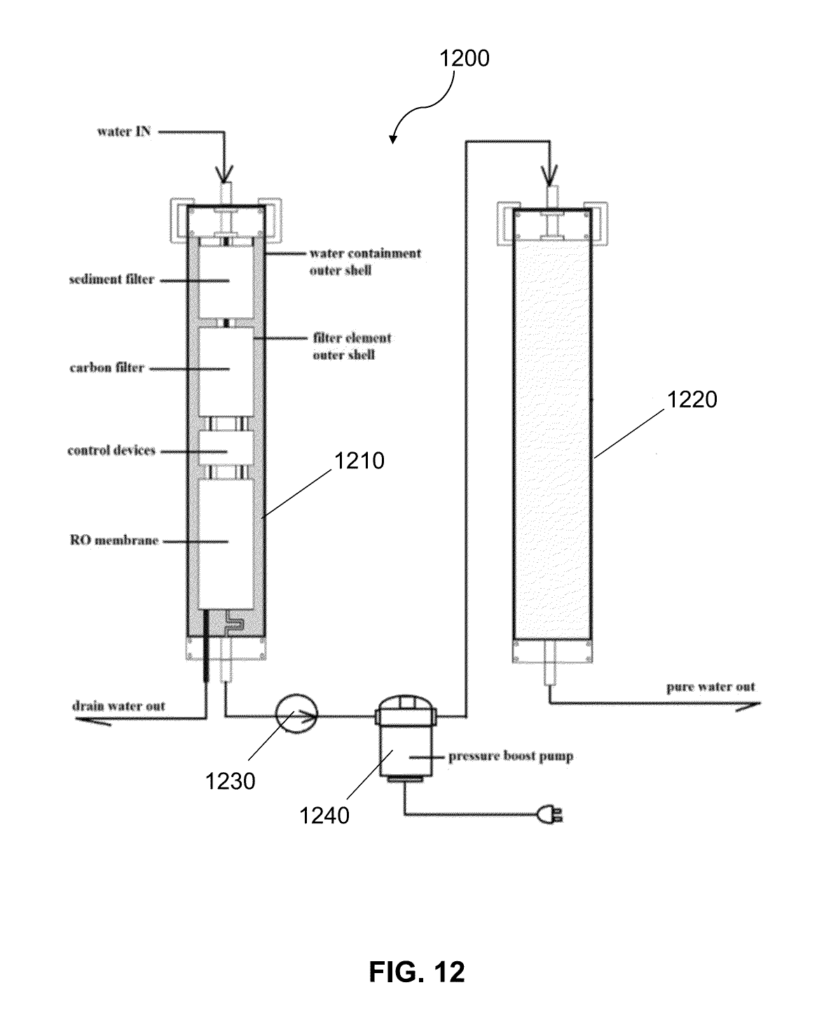

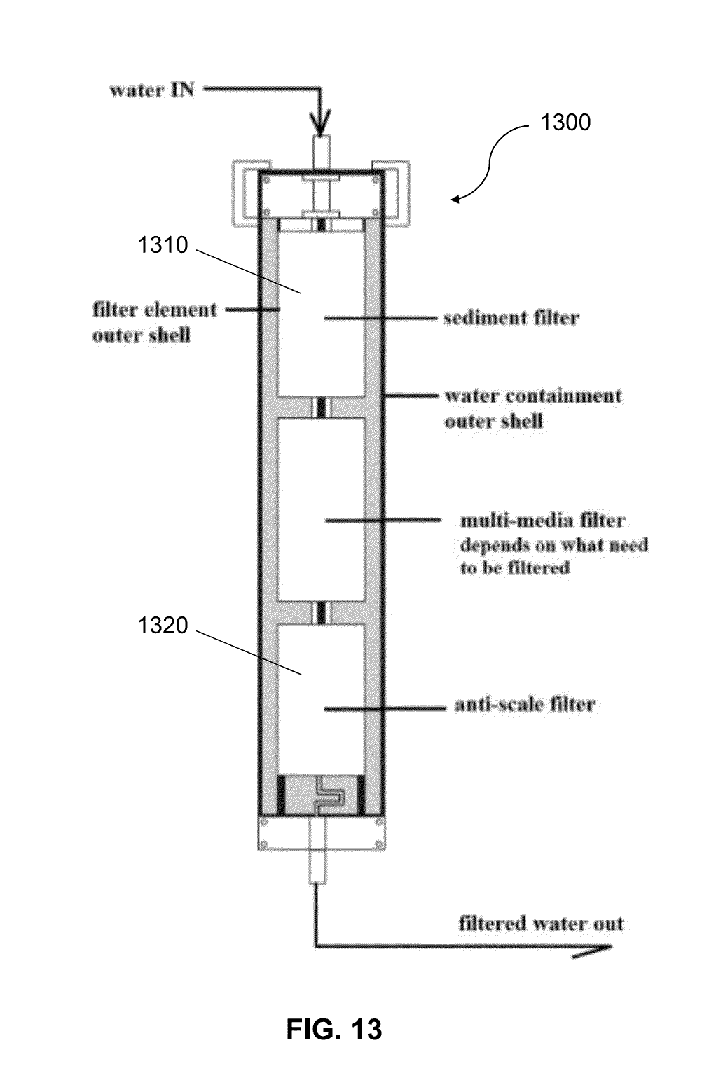

FIG. 12 shows another configuration of a water filtering system 1200, which includes an RO system 1210, an empty tubular chamber 1220, a first pump 1230 and a second pump 1240. When the water is output from the RO system 1210, the water can be pumped and stored in the tubular chamber 1220, and the water in the tubular chamber 1220 can be sucked out by the second pump 1240. In FIG. 13, a water filtration system 1300 may include a sediment filter 1310 and an anti-scale media 1320. It is noted that a check valve is needed so that the air is not sucked in form the output line. It is also noted that either the filters or the components of the RO system can be disposed vertically inside the shell so the filters and components can be protected therein. Furthermore, if water leaking occurs, the water will be retained in the shell without causing further water damages. Also, since the filters are disposed inside the shell, the filters will not be affected by external environmental conditions such as cold/hot weather, pressure, moisture, vibration, etc.

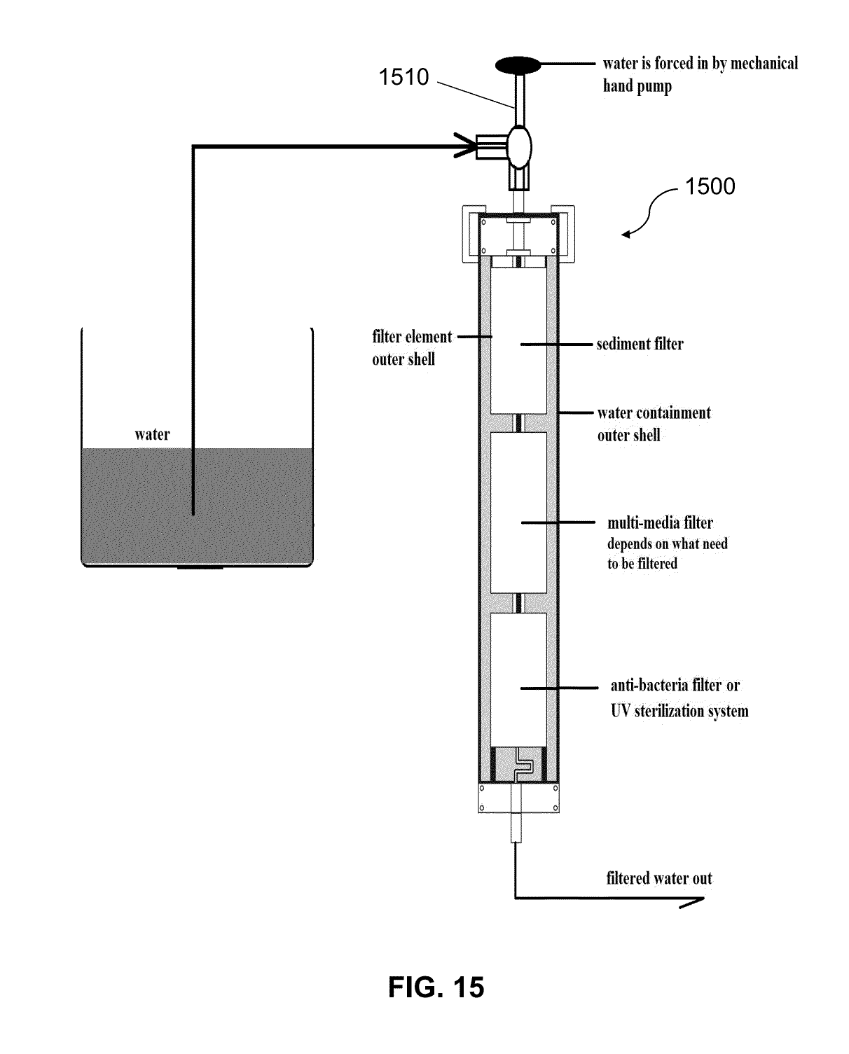

In another aspect, a water tank 1410 with water is disposed on top of a filtration system 1400, which includes a plurality of filters inside a shell 1420. With this configuration, the water can be driven by gravity to pass through the filtration system 1400. In one embodiment, the water can be driven by a mechanical pump 1510 as shown in FIG. 15, where the water can be pumped from outside into a filtration system 1500, and purified or filtered water can be collected at the bottom thereof.

In a further embodiment, a water filtration system 1600 can be disposed in a water reservoir, river, or pond to purify the water therein. One end of the filtration system 1600 can be coupled with a vacuum pump 1610 to drive the water from the other end of the filtration system 1600 into the system, and the filtered or purified water can be collected from the pump end. In still a further embodiment, a filtration system 1600 can be disposed on a boat and when the boat is moving, the water can be collected to a water collector on the boat.

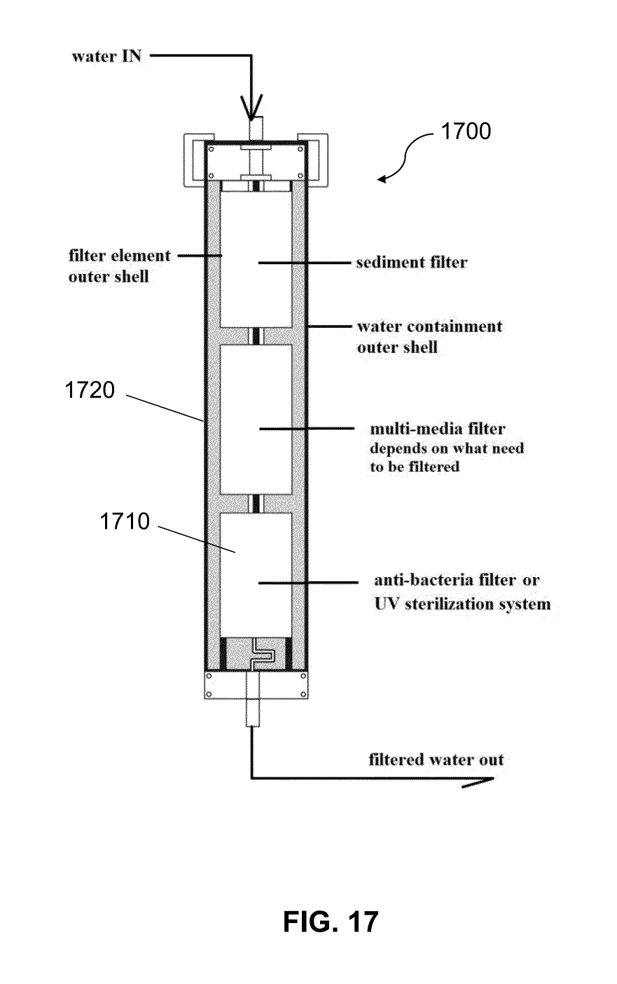

FIG. 17 shows a filtration system 1700 that includes at least one UV system 1710 inside a shell 1720. It is known that the UV system 1710 is fragile and can be easily damaged due to external conditions, so it is advantageous to dispose the UV system 1710 inside the shell 1720 to avoid adversary effect from environment.

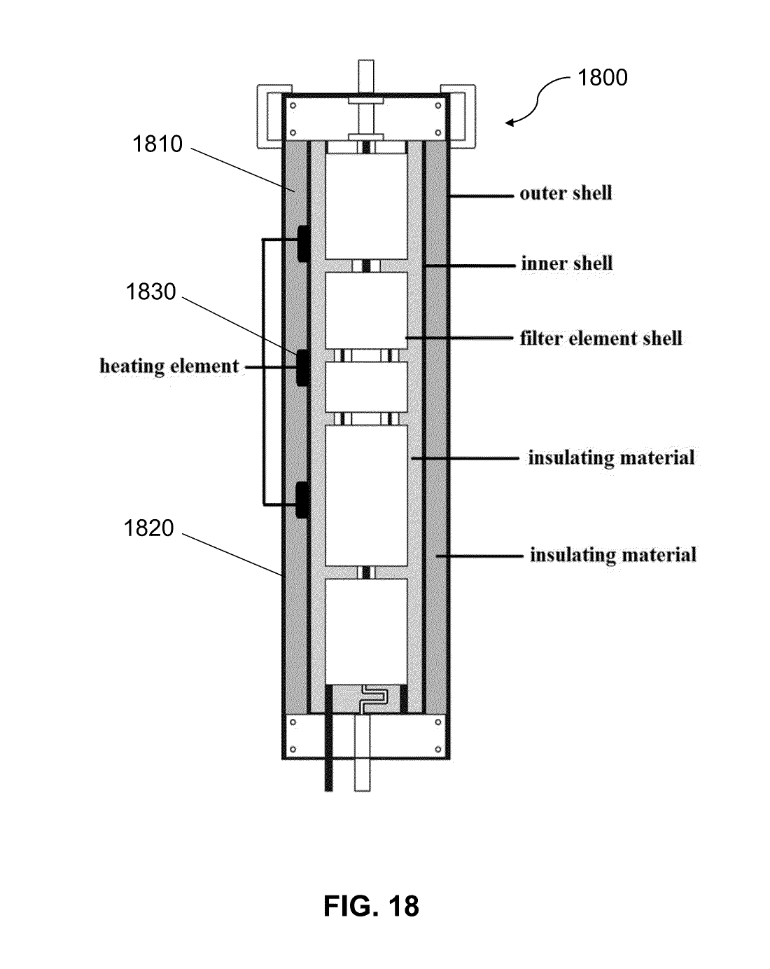

FIG. 18 shows a water filtration system 1800 that is configured to survive cold weather. The filtration system 1800 may include insulation materials 1810 inside a shell 1820. With the insulation materials 1810, the filters are protected inside the shell 1820 to avoid adversary effect caused by cold weather. In another embodiment, the insulation materials 1810 can be replaced by a plurality of heating elements 1830. In a further embodiment, if the weather is extremely cold, the insulation materials 1810 and the heating elements 1830 can be used together. On the contrary, the filtration system 1800 can be used under a hot weather condition when heat-resistant materials are filled inside the shell 1820.

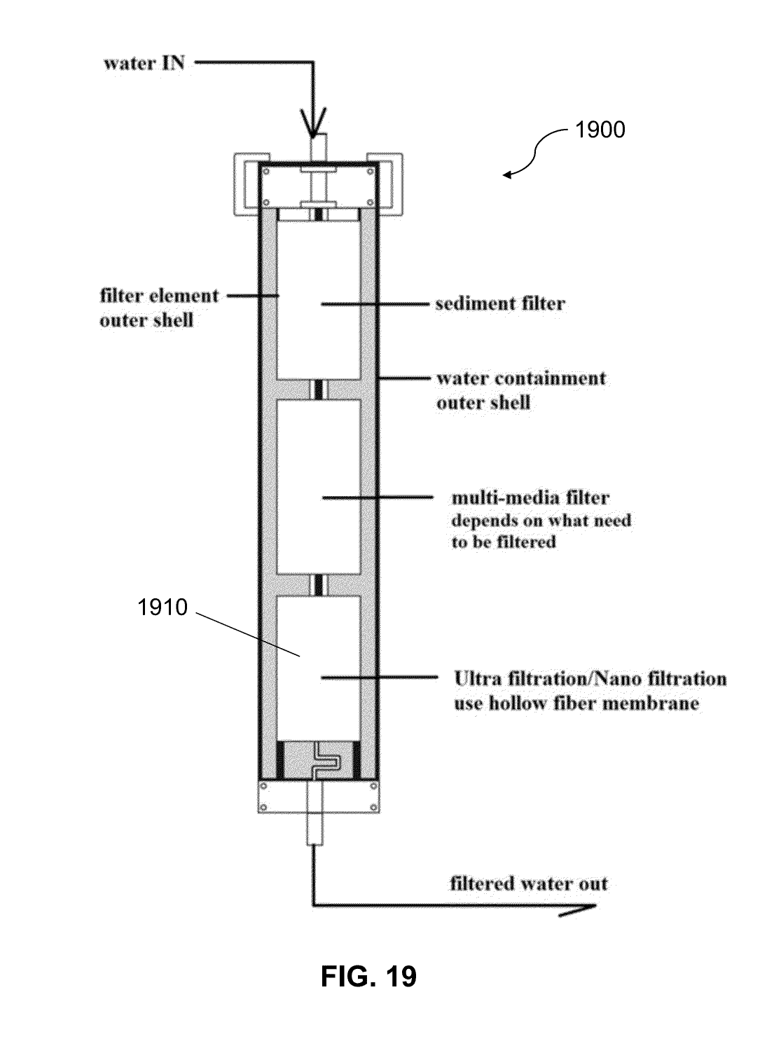

Hollow fiber modules may include an assembly of self-supporting fibers with dense skin separation layers, and a more open matrix helping to withstand pressure gradients and maintain structural integrity. FIG. 19 shows a water filtration system 1900 including a hollow fiber membrane 1910, which can significantly increase the filtration efficiency.

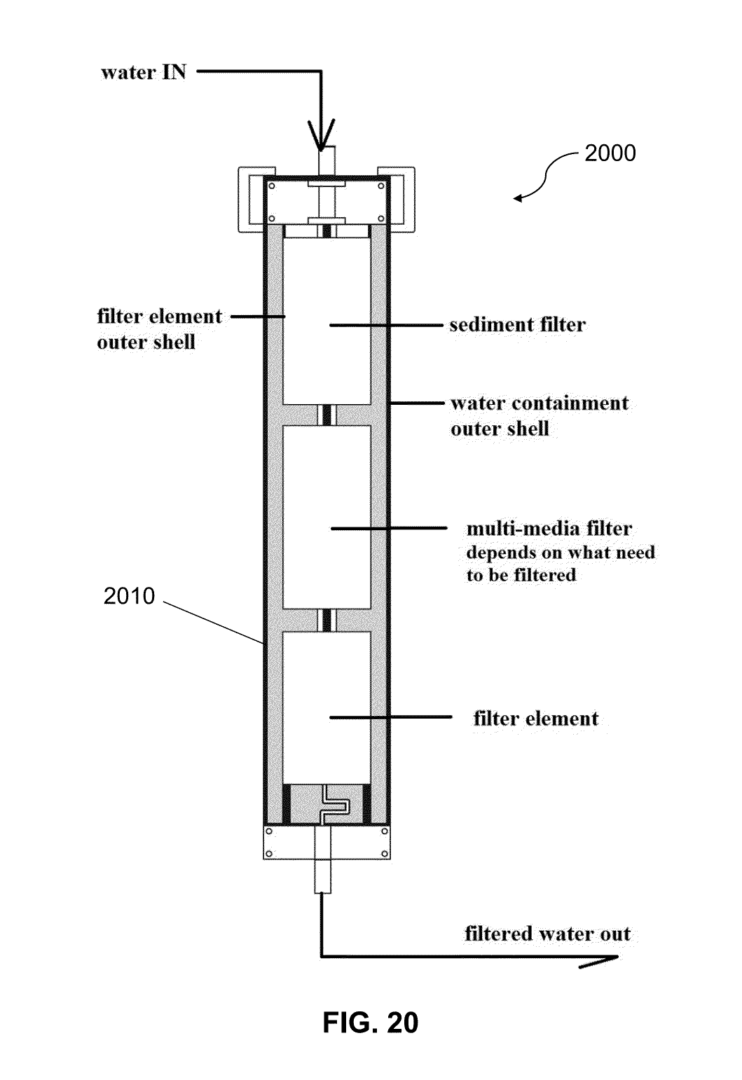

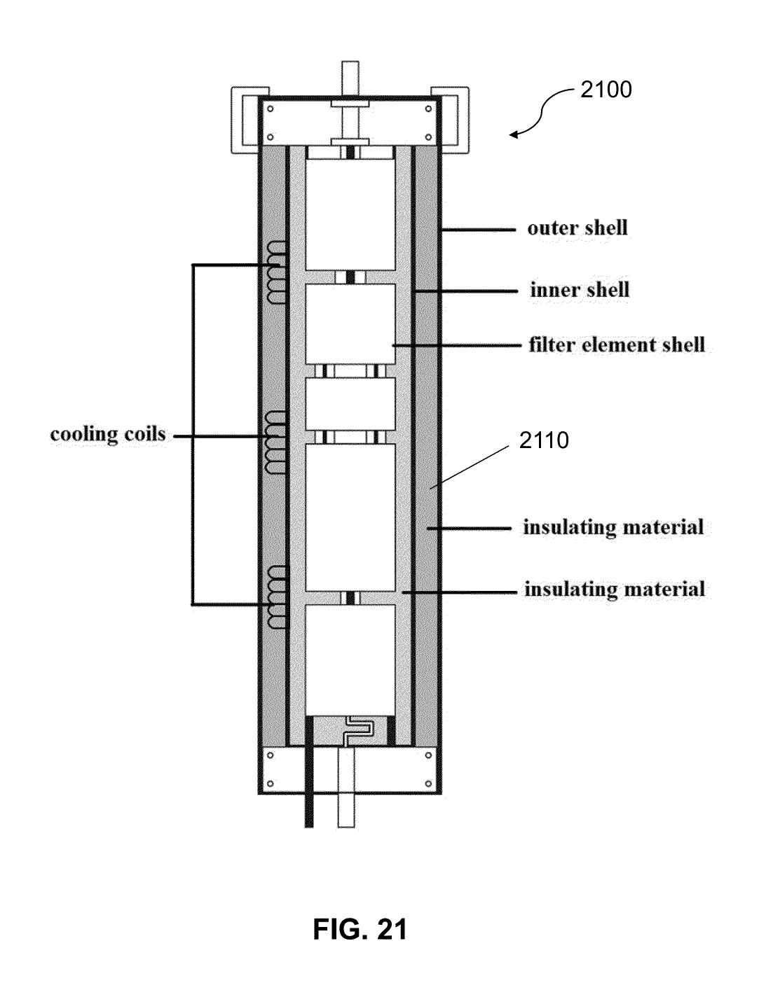

Under a monstrous or wet environment, metal shell of the filtration system may become rusty easily. As shown in FIG. 20, a PVC or fiberglass tubular shell 2010 can be used in the water filtration system 2000 to prevent the shell from being rusty. Also, the fitting and tubing should be made by plastic materials to prevent the rust as well. On the contrary, as shown in FIG. 21, under a hot weather condition, an insulating material 2110 should be used to cover the fitting and tubing, and the filters in the shell of the water filtration system 2100. The insulating material 2100 should be used as a heat barrier or heat resistant, and cannot conduct or transfer heat.

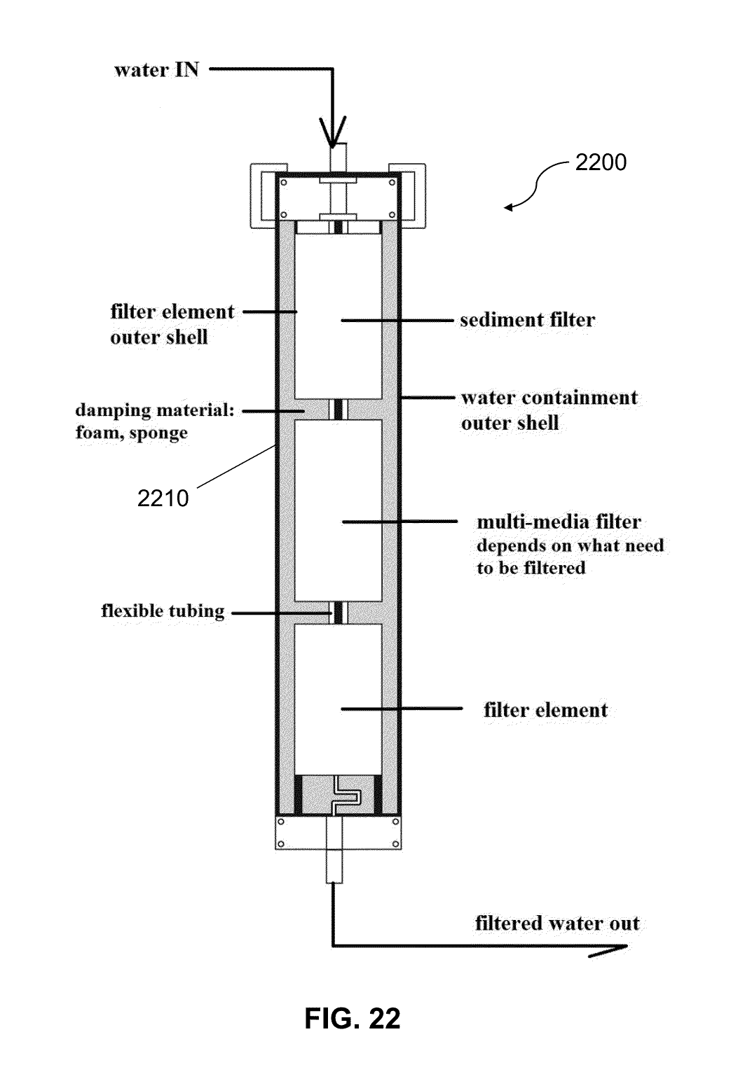

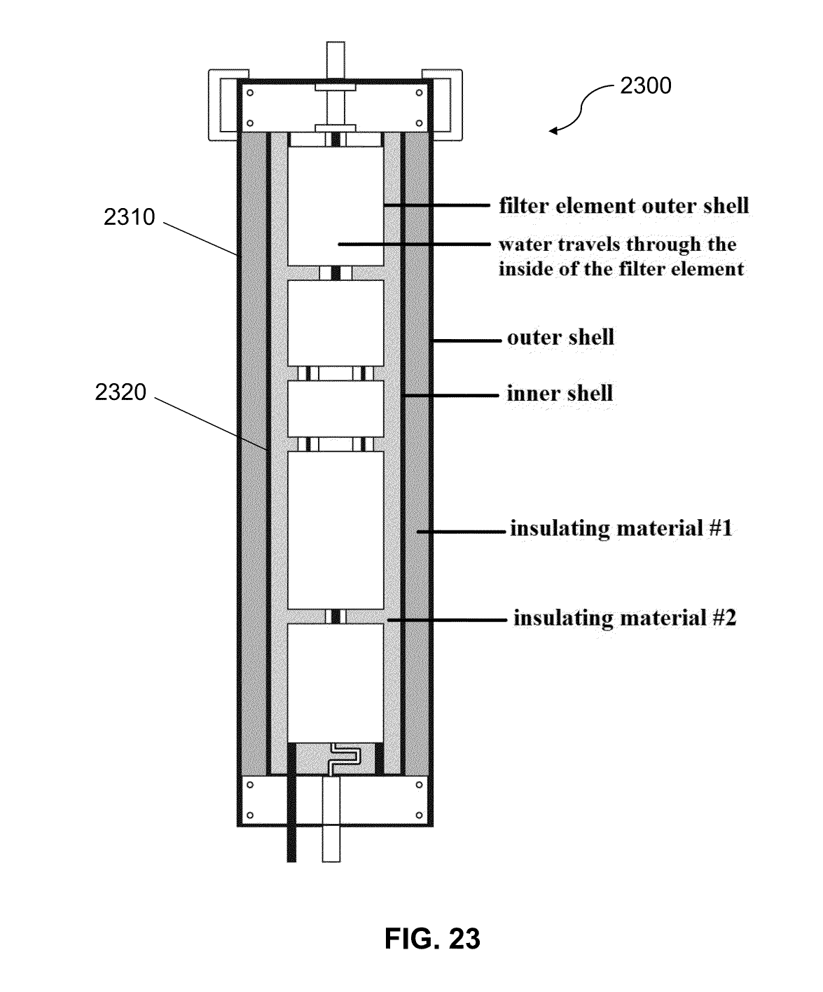

FIG. 22 shows a water filtration system 2200 that can be used under a vibrating environment because a damping material 2210 is filled in the shell of the filtration system. The main advantage of the present invention is to protect the filters from being damaged under different external conditions, including weather, vibration, shocking, etc. FIG. 23 shows a water filtration system 2300 which provides multiple-layered shells including an outer shell 2310 and an inner shell 2320 to better protect the filters therein from external environmental conditions.

Comparing with conventional water filtrating or RO systems, the present invention is advantageous because the filters are vertically disposed inside the shell, which may be single-layered or multi-layered, so the filters are protected from being damaged and able to survive extreme weather conditions and/or external environmental conditions such as hot/cold weather, moisture, vibration, shock, etc. Moreover, the size of the entire system is significantly reduced because the filters or filtering components are all vertically disposed inside the shell, so the user can use more than one system to increase the water output or filtration efficiency. Also, if the filter leaks, the water will be retained in the shell to avoid flooding or other more serious problems.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A water filtering system comprising a filtering unit having plurality of filters vertically disposed in a receiving space of a shell of the filtering unit, wherein water to be filtered is introduced into the filters from an upper portion of the shell and water being filtered flows out at a bottom portion thereof.

2. The water filtering system of claim 1, wherein the water filtering unit is coupled with a first reverse osmosis (RO) unit that includes controls and a plurality of membranes arranged vertically inside a shell to further purify the filtered water.

3. The water filtering system of claim 2, wherein the controls include an auto shut-off valve, a check valve, sensors, pumps, gauges, flow meter, permeate pump, switches, thermocouple, etc.

4. The water filtering system of claim 2, wherein the first RO unit is coupled with a second RO unit that has at least one sediment filter and one carbon filter arranged in a vertical manner in a shell of the RO unit.

5. The water filtering system of claim 2, wherein a permeate pump is disposed in the shell of the first RO unit to increase the water pressure and further increase the water output rate.

6. The water filtering system of claim 2, wherein the first RO unit includes a pump assembly comprising a pump, a transformer, a solenoid valve, and a pressure switch.

7. The water filtering system of claim 4, wherein the second RO unit includes a pump assembly comprising a pump, a transformer, a solenoid valve, and a pressure switch.

8. The water filtering system of claim 1, wherein an anti-scale filter is disposed in the shell.

9. The water filtering system of claim 1, wherein the water filtration system is disposed in a water reservoir, river, or pond to purify the water therein; one end of the filtration system is coupled with a vacuum pump to drive the into the system, and the filtered or purified water can be collected from the other end of the water filtration system.

10. The water filtering system of claim 1, wherein the filtering unit includes a UV system.

11. The water filtering system of claim 1, wherein an insulating material is filled in the shell of the filtering unit, so the filtering unit is configured to be used under a cold weather condition.

12. The water filtering system of claim 11, wherein the insulating material includes heating elements.

13. The water filtering system of claim 1, wherein the shell is made by PVC or fiberglass.

14. The water filtering system of claim 1, wherein a damping material is filled in the shell of the water filtration system, so the system is configured to be operated under a vibrating environment.

15. The water filtering system of claim 1, wherein the shell includes an outer shell and an inner shell to better protect the filters therein from external environmental conditions
